(19) United States
(12) Patent Application Publication
(10) Pub. No.: US 2009/0326760 A1
(43) Pub. Date: Dec. 31, 2009

(54) LOCATION BASED METHOD FOR IMPROVING VEHICLE CABIN AIR QUALITY

(75) Inventors: Jason W. Clark, Grosse Pointe Woods, MI (US); Jeffrey P. Christensen, Clinton Township, MI (US); Michelle L. Michelini, Plymouth, MI (US); Steven C. Tengler, Grosse Point Park, MI (US)

Correspondence Address: Leydig, Voit & Mayer, Ltd., Two Prudential Plaza, Suite 4900, 180 North Stetson Avenue, Chicago, IL, 60601-6731, US

(73) Assignee: GENERAL MOTORS CORPORATION, Detroit, MI (US)

(21) Appl. No.: 12/164,968

(22) Filed: Jun. 30, 2008

(51) Int. Cl. G06F 7/00; B60H 3/00

(52) U.S. Cl. 701/36; 454/75

(57) ABSTRACT

Ways are provided for improving the in-cabin air quality of a vehicle by automatically adjusting the HVAC system settings sufficiently in advance of approaching a location associated with an air quality hazard. In one example, the vehicle's telematics unit correlates the vehicle's position information with locations of static and dynamic air quality hazards, including locations of incidents potentially affecting the air quality in vicinity of the vehicle's location and issues instructions to adjust the HVAC settings to minimize the impact on in-cabin air quality.

### FIELD OF THE INVENTION

This invention relates generally to the field of telematics and more specifically to vehicle cabin air quality control based on location and incident data.

### BACKGROUND OF THE INVENTION

A growing number of modern vehicles incorporate telematics devices for providing navigational assistance in a mobile environment. As part of providing navigational assistance, a vehicle telematics unit typically correlates road network data with the vehicle's current location and conveys vehicle's location information and/or driving directions to the driver via a graphical interface.

When the vehicle travels through an area with compromised air quality, such as locations of pollution-producing plants or locations of incidents that affect the surrounding air quality, the in-cabin air quality is negatively affected if the vehicle's heating, ventilation, and air conditioning (HVAC) system settings are not adjusted in time to reduce the amount of outside air entering the cabin. For example, when the vehicle is traveling in the vicinity of a chemical fire accident, a significant amount of air-borne toxic substances may enter the cabin if the HVAC controls are not switched to a re-circulated mode sufficiently in advance of approaching the affected area. When the vehicle occupants are not aware of, or simply do not have time to react to, the surrounding air quality hazard, the in-cabin air quality will be compromised.

### BRIEF SUMMARY OF THE INVENTION

A system and method are provided for improving the in-cabin air quality of a vehicle by automatically adjusting the HVAC system settings sufficiently in advance of approaching a location associated with an air quality hazard. In one example, the vehicle's telematics unit correlates the vehicle's position information with locations of static and dynamic air quality hazards, including locations of incidents potentially affecting the air quality in vicinity of the vehicle's location and issues instructions to adjust the UVAC settings to minimize the impact on in-cabin air quality.

In one aspect of the invention, a system is provided for improving in-cabin air quality of a vehicle, the system comprising an air quality hazard database comprising a computer readable medium having stored thereon at least one of a static air quality hazard location and a dynamic air quality hazard location, each of the air quality hazard locations associated with compromised air quality, a vehicle telematics unit capable of receiving input comprising the at least one of the static air quality hazard location and the dynamic air quality hazard location, and wherein the vehicle telematics unit issues instructions to adjust the vehicle's climate controls to minimize an impact of an air quality hazard on the in-cabin air quality when the vehicle enters a hazardous area associated with each of the air quality hazard locations.

### BRIEF DESCRIPTION OF THE DRAWINGS

FIG. 1 is a schematic diagram illustrating a system for delivery of in-vehicle telematics services, as contemplated by an example of the present invention;

FIG. 2 is a schematic diagram illustrating a vehicle traveling in the direction of a hazardous area associated with an air quality hazard location, in accordance with an example of the invention;

FIG. 3 is a system diagram illustrating a vehicle telematics unit and an air quality hazard database, in accordance with an example of the invention; and

FIG. 4 is a flow chart illustrating a method for improving the in-cabin air quality of a vehicle in accordance with an example of the invention.

### DESCRIPTION OF AN EXEMPLARY EMBODIMENT

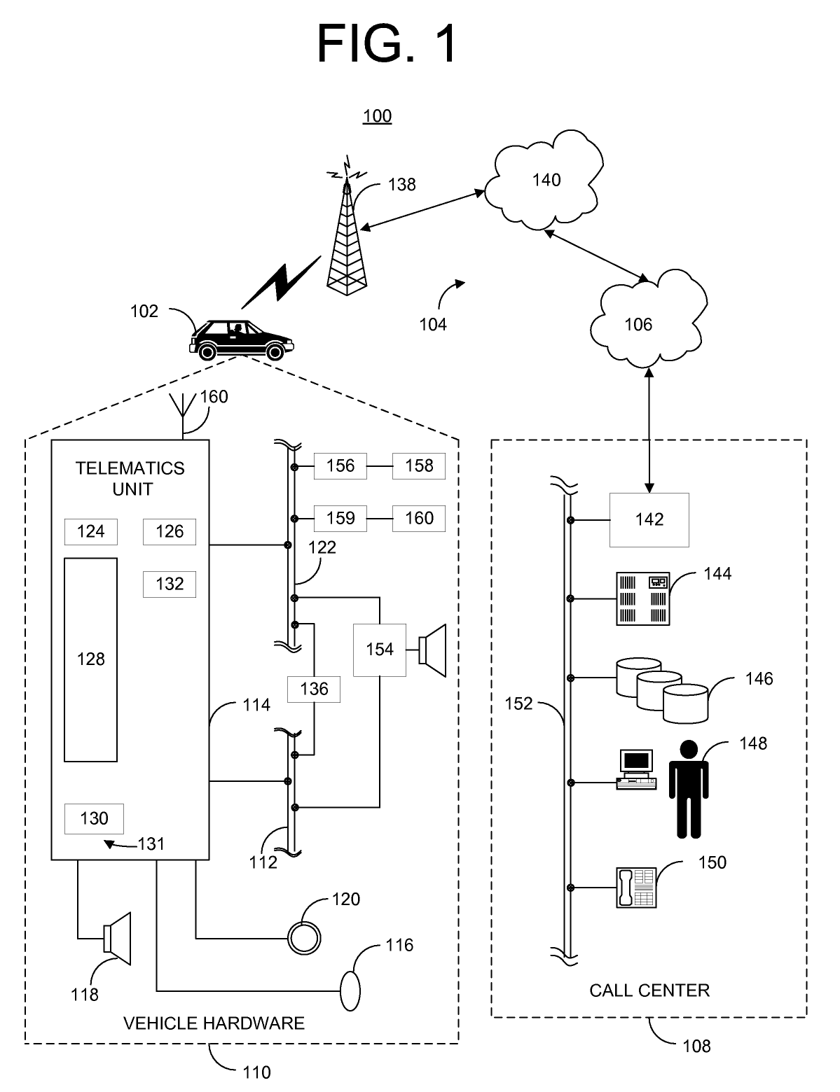

With reference to FIG. 1 there is shown an example of a communication system 100 that may be used with the present method and generally includes a vehicle 102, a wireless carrier system 104, a land network 106 and a call center 108. It should be appreciated that the overall architecture, setup and operation, as well as the individual components of a system such as that shown here are generally known in the art. Thus, the following paragraphs simply provide a brief overview of one such exemplary information system 100, however, other systems not shown here could employ the present method as well.

Vehicle 102 is preferably a mobile vehicle such as a motorcycle, car, truck, recreational vehicle (RV), boat, plane, etc., and is equipped with suitable hardware and software that enables it to communicate over system 100. Some of the vehicle hardware 110 is shown generally in FIG. 1 including a telematics unit 114, a microphone 116, a speaker 118 and buttons and/or controls 120 connected to the telematics unit 114. Operatively coupled to the telematics unit 114 is a network connection or vehicle bus 122. Examples of suitable network connections include a controller area network (CAN), a media oriented system transfer (MOST), a local interconnection network (LIN), an Ethernet, and other appropriate connections such as those that conform with known ISO, SAE, and IEEE standards and specifications, to name a few.

The telematics unit 114 is an onboard device that provides a variety of services through its communication with the call center 108, and generally includes an electronic processing device 128, one or more types of electronic memory 130 having stored thereon software 131, a cellular chipset/component 124, a wireless modem 126, a dual antenna 160 and a navigation unit containing a GPS chipset/component 132. In one example, the wireless modem 126 is comprised of a computer program and/or set of software routines executing within processing device 128.

The telematics unit 114 provides too many services to list them all, but several examples include: turn-by-turn directions and other navigation-related services provided in conjunction with the GPS based chipset/component 132; airbag deployment notification and other emergency or roadside assistance-related services provided in connection with various crash and or collision sensor interface modules 156 and sensors 158 located throughout the vehicle. Infotainment-related services where music, Web pages, movies, television programs, videogames and/or other content is downloaded by an infotainment center 136 operatively connected to the telematics unit 114 via vehicle bus 122 and audio bus 112. In one example, downloaded content is stored for current or later playback.

Again, the above-listed services are by no means an exhaustive list of all the capabilities of telematics unit 114, as should be appreciated by those skilled in the art, but are simply an illustration of some of the services that the telematics unit is capable of offering. It is anticipated that telematics unit 114 will include a number of known components in addition to those listed above.

Vehicle communications preferably use radio transmissions to establish a voice channel with wireless carrier system 104 so that both voice and data transmissions can be sent and received over the voice channel. Vehicle communications are enabled via the cellular chipset/component 124 for voice communications and a wireless modem 126 for data transmission. In order to enable successful data transmission over the voice channel, wireless modem 126 applies some type of encoding or modulation to convert the digital data so that it can communicate through a vocoder or speech codec incorporated in the cellular chipset/component 124. Any suitable encoding or modulation technique that provides an acceptable data rate and bit error can be used with the present method. Dual mode antenna 160 services the GPS chipset/component and the cellular chipset/component.

Microphone 116 provides the driver or other vehicle occupant with a means for inputting verbal or other auditory commands, and can be equipped with an embedded voice processing unit utilizing a human/machine interface (HMI) technology known in the art. Conversely, speaker 118 provides verbal output to the vehicle occupants and can be either a stand-alone speaker specifically dedicated for use with the telematics unit 114 or can be part of a vehicle audio component 154. In either event, microphone 116 and speaker 118 enable vehicle hardware 110 and call center 108 to communicate with the occupants through audible speech. The vehicle hardware also includes one or more buttons or controls 120 for enabling a vehicle occupant to activate or engage one or more of the vehicle hardware components 110. For example, one of the buttons 120 can be an electronic pushbutton used to initiate voice communication with call center 108 (whether it be a live advisor 148 or an automated call response system). In another example, one of the buttons 120 can be used to initiate emergency services.

The audio component 154 is operatively connected to the vehicle bus 122 and the audio bus 112. The audio component 154 receives analog information, rendering it as sound, via the audio bus 112. Digital information is received via the vehicle bus 122. The audio component 154 provides AM and FM radio, CD, DVD, and multimedia functionality independent of the infotainment center 136. Audio component 154 may contain a speaker system, or may utilize speaker 118 via arbitration on vehicle bus 122 and/or audio bus 112.

The vehicle crash and/or collision detection sensor interface 156 are operatively connected to the vehicle bus 122. The crash sensors 158 provide information to the telematics unit via the crash and/or collision detection sensor interface 156 regarding the severity of a vehicle collision, such as the angle of impact and the amount of force sustained.

Vehicle sensors 159, connected to various sensor interface modules 134 are operatively connected to the vehicle bus 122. Examples of vehicle sensors include but are not limited to gyroscopes, accelerometers, magnetometers, emission detection and/or control sensors, and the like. Example sensor interface modules 134 include powertrain control, climate control, and body control, to name but a few.

Wireless carrier system 104 is preferably a cellular telephone system or any other suitable wireless system that transmits signals between the vehicle hardware 110 and land network 106. According to an example, wireless carrier system 104 includes one or more cell towers 138, base stations and/or mobile switching centers (MSCs) 140, as well as any other networking components required to connect the wireless system 104 with land network 106. As appreciated by those skilled in the art, various cell tower/base station/MSC arrangements are possible and could be used with wireless system 104. For example, a base station and a cell tower could be co-located at the same site or they could be remotely located, and a single base station could be coupled to various cell towers or various base stations could be coupled with a single MSC, to name but a few of the possible arrangements. Preferably, a speech codec or vocoder is incorporated in one or more of the base stations, but depending on the particular architecture of the wireless network, it could be incorporated within a Mobile Switching Center or some other network components as well.

Land network 106 can be a conventional land-based telecommunications network that is connected to one or more landline telephones and connects wireless carrier network 104 to call center 108. For example, land network 106 can include a public switched telephone network (PSTN) and/or an Internet protocol (IP) network, as is appreciated by those skilled in the art. Of course, one or more segments of the land network 106 can be implemented in the form of a standard wired network, a fiber of other optical network, a cable network, other wireless networks such as wireless local networks (WLANs) or networks providing broadband wireless access (BWA), or any combination thereof.

Call center 108 is designed to provide the vehicle hardware 110 with a number of different system back-end functions and, according to the example shown here, generally includes one or more switches 142, servers 144, databases 146, live advisors 148, as well as a variety of other telecommunication and computer equipment 150 that is known to those skilled in the art. These various call center components are preferably coupled to one another via a network connection or bus 152, such as the one previously described in connection with the vehicle hardware 110. Switch 142, which can be a private branch exchange (PBX) switch, routes incoming signals so that voice transmissions are usually sent to either the live advisor 148 or an automated response system, and data transmissions are passed on to a modem or other piece of equipment 150 for demodulation and further signal processing. The modem 150 preferably includes an encoder, as previously explained, and can be connected to various devices such as a server 144 and database 146. For example, database 146 could be designed to store subscriber profile records, subscriber behavioral patterns, or any other pertinent subscriber information. Although the illustrated example has been described as it would be used in conjunction with a manned call center 108, it will be appreciated that the call center 108 can be any central or remote facility, manned or unmanned, mobile or fixed, to or from which it is desirable to exchange voice and data.

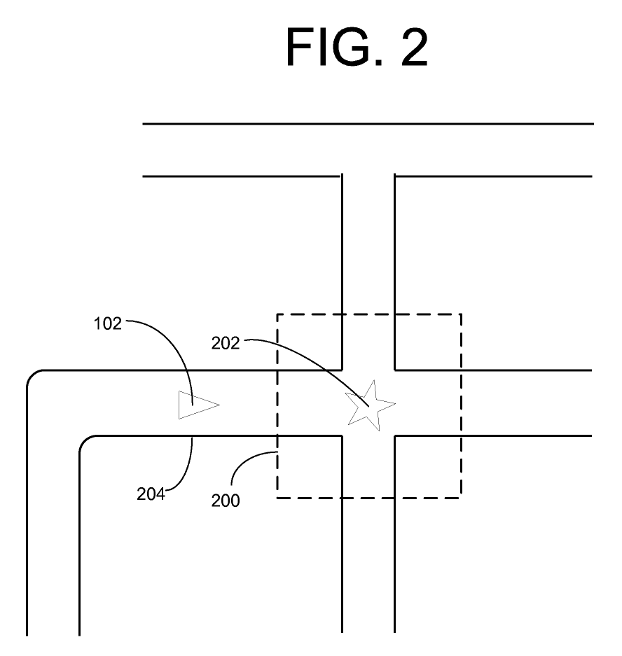

Referring to FIG. 2, to proactively improve air quality inside the vehicle 102, the telematics unit 114 issues computer executable instructions to adjust the vehicle climate control hardware when the vehicle 102 enters a hazardous geo box or area 200. Preferably, the hazardous geo box 200 represents a geographical area around an air quality hazard location 202 of a size and/or shape sufficient to allow the vehicle 102 enough time to adjust the settings of the climate control hardware to reduce the risk of in-cabin air quality contamination prior to arriving at the air quality hazard location 202. In one example, the hazardous area 200 comprises a rectangular or square-shaped geographical area defined via a set of latitude and longitude coordinates for each of its corners, wherein each corner is located a predetermined distance from the air quality hazard location 202. In another example, the hazardous area 200 is calculated based on a pre-defined radial distance from the air quality hazard location 202 and comprises a circular-shaped geographical area. In yet another example, the size and shape of the hazardous area 200 are dynamically adjusted to take into account road traffic conditions (e.g., based on an average speed of the vehicle 102 along a given road segment 204), as well as specific dynamics of a given air quality hazard, such as prevalence of the air quality hazard along a given direction or road due to wind conditions. Alternatively, the size and shape of the hazardous area 200 are predetermined for all vehicle locations or for all vehicles traveling along a given road segment 204 having a known speed limit. When the vehicle 102 enters the hazardous area 200, the telematics unit 114 issues instructions to adjust the climate control settings to minimize the potential impact of the air quality hazard on the vehicle's occupants. For example, the vehicle 102 is instructed to switch to a re-circulated air mode to prevent (or significantly reduce the amount of) outside air from entering the vehicle cabin in advance of arriving at the air quality hazard location 202. Other examples of climate control adjustments include turning off the heating, ventilation, and air conditioning (HVAC) fan, reducing the speed of the HVAC fan, electronically activating a vent closing mechanism, and switching from a heating mode to a cooling mode or vice versa.

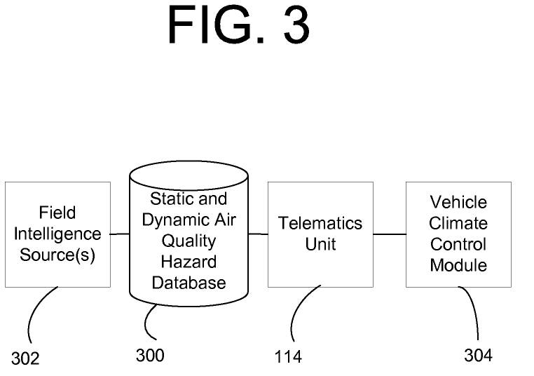

Referring to FIG. 3, the telematics unit 114 receives input of static and dynamic air quality hazard locations 202 from an air quality hazard database 300. The air quality hazard database 300 resides at the call center 108. Alternatively, the air quality hazard database 300 resides at the vehicle 102 and receives periodic and/or on-demand updates from the call center 108. The air quality hazard database 300 is populated based on the information originating from one or more intelligence sources 302. The intelligence sources 302 provide geocoded locations of air quality incidents and include reports originating from other vehicles and/or callers in the field, news reports, and information on locations of static air quality hazards. Static air quality hazard locations include known geographical locations which are likely to have a compromised air quality in their vicinity and/or on their premises. Examples of static air quality hazard locations include, but are not limited to, locations of industrial plants and road tunnels, as well other geographical locations permanently associated with air quality hazards, including air pollution. Dynamic air quality hazard locations include locations of reported events that pose a threat to surrounding air quality, such as locations of current and/or recent hazardous waste accidents, fires (including chemical fires), and locations of other emergency or non-emergency events that may pose an air quality concern. In one example, air quality hazard locations 202 include locations potentially associated with offensive scents (e.g., locations of agricultural facilities, including animal farms). In yet another example, the static and/or dynamic air quality hazard locations are user-defined via an electronic interface, such as a Web form presented via an Internet connection at the user's home, car, or mobile telephone.

Upon receipt of an air quality hazard alert from the air quality hazard database 300 (e.g., either pushed from the call center 108 or requested by the telematics unit 114), the telematics unit 114 stores the air quality hazard location 202 in its memory, computes the location of the vehicle 102, and, optionally, computes the boundaries of the hazardous area 200. In one example, the call center 108 computes the boundaries of the hazardous area 200 and includes it in the air quality hazard alert. In another example, the telematics unit 114 computes the boundaries of the hazardous area 200 based at least on the location of the vehicle 102 with respect to the air quality hazard location 202. The telematics unit 114 issues commands to the vehicle climate control module 304 for adjusting the HVAC controls when the location of the vehicle 102 falls within the hazardous area 200. The vehicle climate control module 304 comprises one or more of hardware, software or firmware for controlling the operation of the vehicle's HVAC system. In one example, the telematics unit 114 or the call center 108 take into account vehicle speed, known traffic conditions, as well as reported wind speed and direction in vicinity of the air quality hazard location 202 to dynamically compute the boundaries of the hazardous area 200.

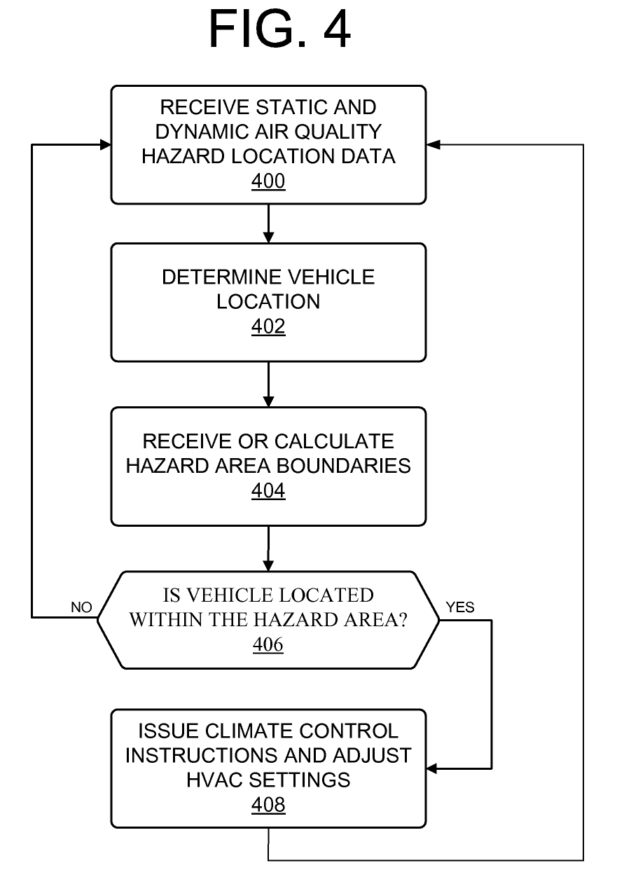

Referring to FIG. 4, an exemplary method for improving the in-cabin air quality of a vehicle passing through the vicinity of an air quality hazard location is shown. In steps 400-402, the telematics unit 114 receives static and/or dynamic air quality hazard location data 202 and determines the current location of the vehicle. In step 404, the telematics unit 114 receives the boundaries of the hazardous area 200 from the call center 108. Alternatively, the telematics unit 114 computes the boundaries of the hazardous area 200, as discussed above in connection with FIG. 3. If the vehicle is located within the boundaries of the hazardous area 200, the telematics unit 114 issues climate control instructions to the climate control module 304 to adjust the vehicle's climate controls in order to minimize the amount of outside air entering the vehicle, steps 406-408. Otherwise, the process returns to step 400. After adjusting the climate control settings, the telematics unit 114 continues to monitor the air quality hazard location data, step 400. In one example, in addition to automatically receiving the air quality hazard alerts, the telematics unit 114 includes a manual update mode allowing a vehicle occupant to request an on-demand update.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A system for improving in-cabin air quality of a vehicle, the system comprising:
an air quality hazard database comprising a computer readable medium having stored thereon at least one of a static air quality hazard location and a dynamic air quality hazard location, each of the air quality hazard locations associated with compromised air quality;
a vehicle telematics unit capable of receiving input comprising the at least one of the static air quality hazard location and the dynamic air quality hazard location; and
wherein the vehicle telematics unit issues instructions to adjust the vehicle's climate controls to minimize an impact of an air quality hazard on the in-cabin air quality when the vehicle enters a hazardous area associated with each of the air quality hazard locations.

2. The system of claim 1 wherein the static air quality hazard location comprises a geographical location permanently associated with the air quality hazard.

3. The system of claim 2 wherein the static air quality hazard location is selected from the group consisting of a location of an industrial plant, location of a road tunnel, and location of an agricultural facility.

4. The system of claim 1 wherein the dynamic air quality hazard location comprises a location of an incident that results in the air quality hazard.

5. The system of claim 4 wherein the dynamic air quality hazard location is selected from the group consisting of a location of a hazardous waste accident and location of a fire.

6. The system of claim 1 wherein at least one of the size and shape of the hazardous area is adjusted based on one or more of a vehicle speed, wind conditions, presence of the air quality hazard along a road segment, and presence of the air quality hazard along a direction.

7. The system of claim 1 wherein at least one of the size and shape of the hazardous area is predetermined.

8. The system of claim 1 wherein the instructions to adjust the vehicle's climate controls are selected from the group consisting of switching to a re-circulated HVAC mode, turning off an HVAC fan, reducing the speed of the HVAC fan, closing air vents, and switching between heating and cooling modes.

9. A method for improving in-cabin air quality of a vehicle, the method comprising:
storing, in a computer readable medium, at least one of a static air quality hazard location and a dynamic air quality hazard location, each of the air quality hazard locations associated with compromised air quality;
transmitting, to a vehicle telematics unit, the at least one of the static air quality hazard location and the dynamic air quality hazard location; and
automatically adjusting the vehicle's climate controls to minimize an impact of an air quality hazard on the in-cabin air quality when the vehicle enters a hazardous area associated with each of the air quality hazard locations.

10. The method of claim 9 wherein the static air quality hazard location comprises a geographical location permanently associated with the air quality hazard.

11. The method of claim 10 wherein the static air quality hazard location is selected from the group consisting of a location of an industrial plant, location of a road tunnel, and location of an agricultural facility.

12. The method of claim 9 wherein the dynamic air quality hazard location comprises a location of an incident that results in the air quality hazard.

13. The method of claim 12 wherein the dynamic air quality hazard location is selected from the group consisting of a location of a hazardous waste accident and location of a fire.

14. The method of claim 9 further comprising adjusting at least one of the size and shape of the hazardous area based on one or more of a vehicle speed, wind conditions, presence of the air quality hazard along a road segment, and presence of the air quality hazard along a direction.

15. The method of claim 9 wherein at least one of the size and shape of the hazardous area is predetermined.

16. The method of claim 9 wherein automatically adjusting the vehicle's climate controls comprises one or more of switching to a re-circulated HVAC mode, turning off an HVAC fan, reducing the speed of the HVAC fan, closing air vents, and switching between heating and cooling modes.

17. A method for improving in-cabin air quality of a vehicle, the method comprising:
receiving, at a vehicle telematics unit, an air quality hazard location, the air quality hazard location associated with compromised air quality; and
automatically adjusting the vehicle's climate controls to minimize an impact of an air quality hazard on the in-cabin air quality when the vehicle enters a hazardous area associated with the air quality hazard location.

18. The method of claim 17 wherein the air quality hazard location comprises a geographical location permanently associated with the air quality hazard.

19. The method of claim 17 wherein the air quality hazard location comprises a location of an incident that results in the air quality hazard.

20. The method of claim 17 wherein the air quality hazard location is selected from the group consisting of a location of an industrial plant, location of a road tunnel, location of an agricultural facility, location of a hazardous waste accident, and location of a fire.
